(19) United States
(12) Patent Application Publication
(10) Pub. No.: US 2005/0273426 A1
(43) Pub. Date: Dec. 8, 2005

(54) Method for using consulting services for multi-task transactions to raise money for non-profit entities

(76) Inventor: Patricia Carol Hammock, Marietta, GA (US)

Correspondence Address: SMITH MOORE LLP, P.O. BOX 21927, GREENSBORO, NC, 27420, US

(21) Appl. No.: 11/148,000

(22) Filed: Jun. 7, 2005

Related U.S. Application Data
(60) Provisional application No. 60/577,565, filed on Jun. 7, 2004.

(51) Int. Cl. G06F 17/60

(52) U.S. Cl. 705/39

(57) ABSTRACT

A method for streamlining multi-task transactions for a customer, such as buying a house or an automobile, and using the multi-task transaction to raise money for a non-profit entity. The method includes establishing a consultant to manage a multi-task transaction on behalf of a customer and designating a non-profit entity to receive a portion of the proceeds received by the consultant for managing the multi-task transaction. The consultant forms partnerships with service providers who agree to perform services in the multi-task transaction and agree to donate a portion of the proceeds received by the service providers for performing the services to the designated non-profit entity. The consultant oversees the completion of the multi-task transaction and the donation of the respective portions of the consultant's and the service providers' proceeds to the designated non-profit entity.

This application claims the benefit of U.S. Provisional Application No. 60/577,565 filed on Jun. 7, 2004.

### BACKGROUND OF THE INVENTION

The present invention is directed towards fundraising, and more particularly, towards a method for using consulting services for multi-task transactions to raise money for non-profit organizations.

Many non-profit entities that depend solely on government funds and/or donations are suffering in today's slow economic market. As a result, many of these organizations are in desperate need of creative fundraising. The present invention proposes a new and exciting method of fundraising that is associated with consulting services for multi-task transactions, as described below.

Any consumer is aware of the exciting, yet time-consuming and sometimes stressful process of buying or selling a home or automobile. These are just two examples of multi-task transactions; particularly, transactions that require multiple steps before completion of the transaction. In a typical case of buying a new home, a buyer begins the home buying process by contracting a licensed real estate agent to help the buyer look for houses in a particular geographic location, in a particular price range, and having certain characteristics such as the number of levels and bedrooms, etc. After visiting several properties and deciding on the most desired one, the buyer hopefully places an offer on a home which is accepted by the existing owner. Next, the buyer generally begins to shop mortgage companies for interest rates and programs, and begins the mortgage application process. During the process of securing a mortgage on the property, the buyer must contact and secure hazard insurance and a closing attorney. In most cases, the buyer also hires a general inspector and a termite company to inspect the property. The buyer may also desire a home warranty and will have to contact an agent for this as well. Even after securing all of the necessary components for closing on the property, the buyer generally has to hire professional movers to move the buyer's furnishings into the new home. The process of contacting all of these companies is a tedious and time-consuming process, which ultimately adds to the stress level of the buyer during that time.

As one can imagine, the above-described process for buying a home is even more stressful to a prospective buyer who is moving to a new area because of a job relocation. While many employers offer relocation packages that include recommendations on real estate agents, the packages do not include ways to streamline the time-consuming process described above. Further, studies have shown that employers are able to reduce turnover and stabilize their workforce by increasing home ownership among their employees. Therefore, employers have a vested interest in encouraging its existing employees to buy homes, in addition to new employees moving to the area.

As mentioned above, another example of a multi-task transaction is buying a new car, which requires coordination of finding a car, getting a car loan, securing car insurance, and getting the car's registration and tags. Similar to buying a new home, this process can be very stressful to the buyer because of all the various components that must be coordinated to drive the car off the car lot.

In view of the forgoing, there is a need in the art for a creative method of raising funds for non-profit entities. There is a further need in the art for consulting services for multi-task transactions that help to streamline processes for consumers and alleviate some of the stress involved with these transactions.

### DESCRIPTION OF THE PRESENT INVENTION

The present invention solves these needs in the art by providing consulting services for multi-task transactions that streamlines processes for consumers while raising money for non-profit organizations.

In order to simply multi-task transactions for consumers, such as the process of buying or selling a residential home or commercial property, the present invention contemplates a consulting agency. It should be understood that the present invention can apply to any multi-task transaction and is not limited to the real estate example described herein.

Referring again to the home buying scenario, the consulting agency partners with a plurality of companies that provide services relating to the home buying and selling process; namely, mortgage companies, closing attorneys, home inspectors, homeowner insurance companies, home warranty companies, title insurance companies, appraisal companies, moving companies, and survey companies. When one is preparing to buy or sell a home, the buyer or seller utilizes the consulting agency to arrange each component of the process with the various service providers, as discussed in more detail below.

One of the main goals of the consulting agency is to bring value to prospective buyers and sellers by easing the process of transacting real estate while giving back to the community and ensuring financial support of non-profit organizations. There are several ways to accomplish this goal that are contemplated by the present invention. In one embodiment, the consulting agency may market its services to individuals, groups of individuals, or organizations. In an additional embodiment, the consulting agency may market its services to various employers, both for-profit and non-profit, as part of an employee benefit program wherein the consulting agency offers to make a charitable contribution to a non-profit entity designated by the employer or employee. The consulting agency is able to achieve this by requiring that each of its contracted service providers also agree to participate in the charitable donation program. For example, if the consulting agency offers its services to an employer such as the public school system as part of an employee benefit program, the consulting agency may require that each of its service providers agree to donate a certain percentage of its service fees back to the school system, since it is a non-profit entity. The service providers may also offer a volume based discount on their services in addition to their charitable contribution as an added benefit to the client. The scenario used to describe the present invention contemplates the public school system as the employer, however, it should be understood that the present invention does not have to be associated with any particular employer or non-profit organization. Rather, this scenario involving a school system is merely exemplary.

If the employer agrees to offer the consultant's services to its employees, the employees are able to take advantage of the streamlined home buying and selling process while also preferably taking advantage of discounts offered by the various service providers. For example, if a new teacher to the school system is moving to the area and decides to buy a new home, the teacher first contacts the consulting agency and requests to participate in the program. The consulting agent then coordinates all of the components needed to locate and buy the home. The consulting agency refers the prospective buyer to a licensed real estate agent. In exchange for the referral, the consultant preferably receives a certain percentage of the real estate commission as a referral fee. After securing a contract on a new home, the prospective buyer and/or real estate agent contacts the consulting agency to give it the contract details. The consulting agency has an alliance with several service providers and is able to serve as the sole or primary contact for the buyer in arranging items such as the closing attorney, inspectors, survey, movers, etc. For example, the consulting agency is able to coordinate getting documentation of employment history and tax forms to the mortgage company and arrange for the inspections and survey to be done in a timely fashion. The consulting agency also makes sure that the closing attorney has everything it needs to finalize the paperwork. This alleviates the excruciating time it takes for the home buyers to research and contact the service providers itself. In a preferred embodiment, the service providers that have contracted with the consulting agency agree to provide discounted service rates to the employees participating in the program, which is an additional benefit to the homebuyer. Also in a preferred embodiment, the contracted service providers agree to contribute funds to the consulting agency for marketing the collaborative services to the public.

As mentioned above, the benefit to the employer is that the consulting agency, and each of its service providers agree to donate a certain percentage of the funds they receive for their respective services to a non-profit entity designated by the employer or employee. For example, the contract could provide that each provider donates 10% of its receipts for the transaction to the non-profit entity. Such contracts could be organized in various ways. For example, each service provider could provide its designated charitable contribution to the consulting agency at closing, which then issues a check to the non-profit organization. Or, each service provider could give the donation directly to the non-profit entity. It should be understood that the present invention is not limited to any particular configuration for distributing the funds. Rather, regardless of how the funds are distributed, it is done so that the employee and/or the service provider are able to write off the donation for tax purposes as appropriate. If the employer is a non-profit entity, it can designate another non-profit organization to receive the funds as part of the program and the funds may be distributed as a “pass-through” donation. In today's society, most companies place emphasis on their community involvement so participating in the process provided by the present invention allows employers to tout their support of employee home buying and non-profit entities.

In view of the forgoing, the present invention provides an improved method for buying houses that benefits prospective home buyers, their employers, and non-profit entities. The same methodology can be applied to other multi-task transactions such as buying a new car, in which case the consulting agency partners with other service providers who agree to donate a percentage of their service fees back to a designated non-profit entity. The consulting agency then works with the customer to provide a streamlined process for buying the new car.

In an additional embodiment of the present invention, a wed-based software application is provided that manages and facilitates the multi-task transaction to make it even easier for customers. The software application is database driven and in the real estate scenario, tracks all homebuyer information relevant to during and after the sale process. The database is also used for marketing purposes and promoting the fundraising program.

When a prospective homebuyer signs up for the service with the consulting agency, the request along with pertinent information about the buyer is added to the database through the web application. The homebuyer is preferably electronically referred to a mortgage loan originator who is involved in the program. The system then notifies the loan originator that it needs to pre-qualify the homebuyer. Once the homebuyer is contacted and an appropriate price range is determined, the loan originator electronically sends a message back to the database along with a copy of the pre-approval letter.

Once the homebuyer has been pre-qualified, a real estate agent is selected by the consulting agency to work with the homebuyer. The agent receives electronic notification of the identity of the homebuyer, contact information and a copy of the pre-qualification letter. The real estate agent then works with the homebuyer to sell or buy a home.

Once the client's request has been satisfied by getting its “new” or “current” house “under contract”, the agent updates the database by putting in the First Multi-Listing Service (FMLS) identification number. The FMLS information is used to determine rates for additional services needed to complete the home buying/selling process (i.e. home owner insurance, title insurance coverage, moving companies, etc.). Rates are preferably stored in a database that is based on various criteria used by the service provider partners. These rates from each service provider are provided to the client (or real estate agent) and the client decides whether to use these vendors. The client (or real estate agent) indicates in the application which service providers are selected.

If the client wants to use the service providers recommended by the consulting agency, then an electronic notification is sent to the service providers (i.e. surveyor, home inspector, home insurance agent, etc.). The notification provides homebuyer information, address information and contact information so the service providers can contact the homebuyer and make arrangements to handle their request. If homebuyer opts not to use the recommended service providers, the buyer's information is not shared. Once notification has gone to all parties, the real estate agent (or homebuyer) can schedule the closing date and time via this web-based application. In a preferred embodiment, the website provides the closing attorney's office locations along with available appointments. Once a closing office, date and time are selected, notification goes to the closing attorney's office with all appropriate information regarding the closing. The following is an example of the type of information will is sent electronically to the closing attorney: buyer's information; buyer's agent information; seller's information; seller's agent information; loan officer's information; whether a survey is needed; home owner insurance agent information; loan pay-off contact information (seller's existing loan information); and service providers contact information and rates quoted. Notification is also sent to the consulting agency notifying it of the pending transaction. The above-described database can be used for on-going reporting, tracking, and marketing to homebuyers and service providers.

In view of the forgoing, the present invention also provides a web based software application that helps to streamline multi-task transactions even more.

Certain modifications and improvements will occur to those skilled in the art upon a reading of the forgoing description. All such modifications and improvements of the present inventions have been deleted herein for the sake of conciseness and readability but are properly within the scope of the following claims.

1. A method for using a multi-task transaction to raise money for a non-profit entity comprising the steps of:
establishing a consultant to manage a multi-task transaction on behalf of a customer;
designating a non-profit entity to receive a portion of the proceeds received by the consultant for managing the multi-task transaction;
the consultant forming at least one partnership with at least one service provider wherein the at least one service provider agrees to perform a service in the multi-task transaction and agrees to donate a portion of the proceeds received by the at least one service provider for performing the service to the designated non-profit entity;
the consultant overseeing the completion of the multi-task transaction; and
the consultant overseeing the donation of the respective portions of the consultant's and the service provider's proceeds to the designated non-profit entity.

2. The method of claim 1 wherein the multi-task transaction is selected from the group consisting of the customer buying a house and the customer buying an automobile.

3. The method of claim 1 wherein the consultant manages the multi-task transaction by serving as the customer's point of contact for completing tasks in the multi-task transaction.

4. The method of claim 1 further comprising the step of the consulting agency providing an interactive website that tracks the status of tasks in the multi-task transaction and enables electronic communication between the customer, the consultant, and the at least one service provider.
